(19) United States
(12) Patent Application Publication
(10) Pub. No.: US 2025/0219823 A1
(43) Pub. Date: Jul. 3, 2025

(54) KEY MANAGEMENT SYSTEM

(71) Applicant: KAZUAR ADVANCED TECHNOLOGIES LTD., Tel-Aviv (IL)

(72) Inventors: Daniel Mondy FINCHELSTEIN, Rishon Lezion (IL); Yaacov FENSTER, Petach Tikvah (IL)

(21) Appl. No.: 18/848,075

(22) PCT Filed: Mar. 13, 2023
(86) PCT No.: PCT/IL2023/050260

§ 371 Date: Sep. 17, 2024

(30) Foreign Application Priority Data
Mar. 17, 2022 (IL) 291459

(51) Int. Cl. H04L 9/08; G06F 1/26

(52) U.S. Cl. CPC H04L 9/088; G06F 1/26

(57) ABSTRACT

A computerized system operatively powered by a first power source that includes a processor and memory unit (PMU) and a persistent memory module configured to store a first secret key portion. A “hybrid” memory module associated with the PMU and being configured to store a second secret key portion and further being operatively powered by a second power source independent of the first power source, thereby maintaining the second key portion, even when the first power source is disconnected from the computerized system. An anti-tampering module configured to detect tampering with the computerized system, and. in response. generate a power disconnect signal for disconnecting the second power source from the “hybrid” memory module, thereby instantaneously erasing the second secret key portion which will result in an undecipherable secret key.

### TECHNOLOGICAL FIELD

The present invention is in the general field of key management, in particular for cyber security applications.

### BACKGROUND

Many cyber security solutions utilize a key or keys that are kept secret and may be applied to the protected data by an authorized party, (say, by encryption, decryption, signing etc.).

The protected data may be, for instance, private data that pertains to individuals (such as the health history of patients), data of commercial value, state security related data, and so forth. It is thus evident that adversary parties (referred to occasionally also as attackers, malicious actors, etc.) are motivated to access the protected data and unduly exploit it (e.g., by ransom demand and/or other malicious purposes). To this end, the adversary parties may try to access the key or keys that are used for decrypting the protected data. Note that throughout the description the terms “decipher” and “decrypt” are used interchangeably. Note also that the terms decipher, decrypt, sign and so forth, are examples of application of the secret key to the protected data.

Accordingly, there are known in the art many key management schemes that aim at safely deploying and protecting keys from being accessed and being unduly exploited by any adversary parties.

Some of the solutions at least partially utilize dedicated hardware such as a Trusted Platform Module (TPM) or Hardware Security Module (HSM) combined with cryptographic solutions, since, as a rule, hardware-based solutions are considered to be safer and harder to tamper with, compared to software-based solutions. However, as often happens in the cyber security world, the adversaries are constantly seeking weaknesses in the hardware component and/or the key management scheme, to exploit them and access and utilize the protected keys for malicious purposes.

There is, thus, a need in the art to provide a new key management solution that overcomes the shortcomings of hitherto known techniques and provides a higher level of confidence that attackers will not be able to access the protected keys on a hardware component, even if they break into the protected system.

### GENERAL DESCRIPTION

In accordance with an aspect of the presently disclosed subject matter, there is provided a computerized system operatively powered by a first power source, the system comprising:
a processor and memory unit (PMU);
a persistent memory module associated with the PMU and configured to store a first secret key portion;
a “hybrid” memory module associated with the PMU and being configured to store a second secret key portion and further being operatively powered by a second power source independent of the first power source, thereby maintaining the second key portion, even when the first power source is disconnected from the computerized system;
an anti-tampering module configured to detect tampering with the computerized system, and, in response thereto, generate, in an anti-tampering mode of operation, a power disconnect signal, for disconnecting the second power source from the “hybrid” memory module, thereby instantaneously erasing the second secret key portion, giving rise to an undecipherable secret key.

In accordance with an embodiment of the presently disclosed subject matter, there is further provided a computerized system, wherein, in case the anti-tampering mode is not encountered, in response to an “unlock secret” command, the PMU is configured to extract the first secret key portion from the persistent memory module and the second key portion from the “hybrid” memory portion, and unlock a secret key based on at least the first secret portion and second secret portion, wherein the unlocked secret key can be applied to the sensitive data.

In accordance with an embodiment of the presently disclosed subject matter, there is yet further provided a computerized system, wherein the persistent memory portion is included in a Trusted Platform Module (TPM).

In accordance with an embodiment of the presently disclosed subject matter, there is yet further provided a computerized system, wherein the PMU is embedded in the TPM and is configured to extract the first secret key portion from the TPM and the second key portion from the “hybrid” memory portion, and unlock a secret key based on at least the first secret portion and second secret portion.

In accordance with an embodiment of the presently disclosed subject matter, there is yet further provided a computerized system, wherein the “hybrid” memory module is a Real Time Clock (RTC) module configured to store the second secret key portion.

In accordance with an embodiment of the presently disclosed subject matter, there is yet further provided a computerized system, wherein the anti-tampering module is separate from the PMU, and is operatively powered by a third power source independent of the first and second power sources, thereby maintaining the anti tampering module as operative, even when the first power source is disconnected.

In accordance with an embodiment of the presently disclosed subject matter, there is yet further provided a computerized system, wherein the anti-tampering module is associated with the PMU, and is operatively powered by the first power source, thereby being inoperative when the first power source is disconnected.

In accordance with an embodiment of the presently disclosed subject matter, there is yet further provided a computerized system, wherein the anti-tampering module is user operated, wherein, in response to a user command (say, a given sequence of key strokes), a power disconnect signal is generated for disconnecting the second power source from the “hybrid” memory module, thereby instantaneously erasing the second secret key portion, giving rise to an undecipherable secret key.

In accordance with an embodiment of the presently disclosed subject matter, there is yet further provided a computerized system, wherein the PMU is configured to obtain the secret key by unlocking the first secret key portion utilizing at least the second secret key portion, or vice versa.

In accordance with an embodiment of the presently disclosed subject matter, there is yet further provided a computerized system, wherein the PMU is configured to obtain the secret key by applying a function on the first secret key portion and the second secret key portion.

In accordance with an embodiment of the presently disclosed subject matter, there is yet further provided a computerized system, wherein the PMU is configured to receive sensitive data for protection and associated at least one cryptographic operation, and utilize the unlocked secret key and cryptographic operations for encrypting the sensitive data.

In accordance with an embodiment of the presently disclosed subject matter, there is yet further provided a computerized system, further comprising a second PMU separate from the PMU, and being configured to utilize the secret key for encrypting sensitive data.

In accordance with an embodiment of the presently disclosed subject matter, there is yet further provided a computerized system, wherein the second portion is extracted during a boot stage of the computerized system.

In accordance with an embodiment of the presently disclosed subject matter, there is yet further provided a computerized system, wherein the persistent memory module is configured to erase data stored therein after the elapse of a first time duration following disconnection of the first power source, and wherein the “hybrid” memory module is configured to erase data stored therein after the elapse of a second time duration (e.g. instantaneously) following disconnection of the second power source, and the second time duration is significantly shorter than the first time duration.

In accordance with an aspect of the presently disclosed subject matter, there is yet further provided a computerized system operatively powered by a first power source, the system comprising:
a processor and memory unit (PMU);
a “hybrid” memory module associated with the PMU and being configured to store a secret key, and further being operatively powered by a second power source independent of the first power source, thereby maintaining the secret key, even when the first power source is disconnected from the computerized system;
an anti-tampering module configured to detect tampering with the computerized system, and, in response thereto, generate, in an anti-tampering mode of operation, a power disconnect signal, for disconnecting the second power source from the “hybrid” memory module, thereby instantaneously erasing the secret key, giving rise to an undecipherable secret key.

In accordance with an embodiment of the presently disclosed subject matter, there is yet further provided a computerized system, wherein, in case the anti-tampering mode is not encountered, in response to an “unlock secret” command, the PMU is configured to extract the secret key from said “hybrid” memory portion, and unlock the secret key, wherein the unlocked secret key can be applied to the sensitive data.

In accordance with an aspect of the presently disclosed subject matter, there is yet further provided a computerized method for unlocking a secret key, comprising, by a computer system operatively powered by a first power source:
a) providing a processor and memory unit (PMU);
b) storing a first secret key portion in a persistent memory module associated with the PMU;
c) storing a second secret key portion in a “hybrid” memory module associated with the PMU, the “hybrid” memory module being operatively powered by a second power source independent of the first power source, thereby maintaining the second key portion, even when the first power source is disconnected from the computerized system; and
d) in response to detecting tampering with the computerized system, generating, in an anti-tampering mode of operation, a power disconnect signal, for disconnecting the second power source from the “hybrid” memory module, thereby instantaneously erasing the second secret key portion, giving rise to an undecipherable secret key.

In accordance with an embodiment of the presently disclosed subject matter, there is yet further provided a computerized method, wherein in case the anti-tampering mode is not encountered, the method further comprises:
e) executing an “unlock secret” command including:
   1) extracting the first secret key portion from the persistent memory module and the second key portion from the “hybrid” memory portion; and
   2) unlocking a secret key based on at least the first secret portion and second secret portion, wherein the unlocked secret key can be applied to the sensitive data.

In accordance with an embodiment of the presently disclosed subject matter, there is yet further provided a computerized method, wherein the persistent memory portion is included in a Trusted Platform Module (TPM).

In accordance with an embodiment of the presently disclosed subject matter, there is yet further provided a computerized method, wherein the PMU is embedded in the TPM, and comprises:
(1) extracting the first secret key portion from the TPM and the second key portion from the “hybrid” memory portion, and
(2) unlocking a secret key based on at least the first secret portion and second secret portion.

In accordance with an embodiment of the presently disclosed subject matter, there is yet further provided a computerized method, wherein the “hybrid” memory module is a Real Time Clock (RTC) module configured to store the second secret key portion.

In accordance with an embodiment of the presently disclosed subject matter, there is yet further provided a computerized method, further comprising unlocking the first secret key portion utilizing at least the second secret key portion, or vice versa.

In accordance with an embodiment of the presently disclosed subject matter, there is yet further provided a computerized method, further comprising obtaining the secret key by applying a function on the first secret key portion and the second secret key portion.

In accordance with an embodiment of the presently disclosed subject matter, there is yet further provided a computerized method, further comprising extracting the second portion during a boot stage of the computerized system.

In accordance with an embodiment of the presently disclosed subject matter, there is yet further provided a computerized method, further comprising erasing data stored in the persistent memory after the elapse of a first time duration following disconnection of the first power source, and erasing data stored in the “hybrid” memory module after the elapse of a second time duration (e.g. instantaneously) following disconnection of the second power source, and the second time duration is significantly shorter than the first time duration.

In accordance with an aspect of the presently disclosed subject matter, there is yet further provided a computerized method for unlocking a secret key comprising by a computer system operatively powered by a first power source:
a) providing a processor and memory unit (PMU);
b) storing a secret key portion in a “hybrid” memory module associated with the PMU, the “hybrid” memory module being operatively powered by a second power source independent of the first power source, thereby maintaining the secret key, even when the first power source is disconnected from the computerized system; and
c) in response to detecting tampering with the computerized system, generating, in an anti-tampering mode of operation, a power disconnect signal, for disconnecting the second power source from the “hybrid” memory module, thereby instantaneously erasing the secret key portion, giving rise to an undecipherable secret key.

In accordance with an embodiment of the presently disclosed subject matter, there is yet further provided a computerized method, wherein in case the anti-tampering mode is not encountered, the method further comprises:
f) executing an “unlock secret” command including:
   1) extracting the secret key portion from the “hybrid” memory portion; and
   2) unlocking a secret key, wherein the unlocked secret key can be applied to the sensitive data.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a functional block diagram of a key management system, in accordance with certain embodiments of the presently disclosed subject matter;

FIG. 2 illustrates a generalized flow-chart of a sequence of operations in a system of FIG. 1, in accordance with certain embodiments of the presently disclosed subject matter;

FIG. 3 illustrates a generalized flow-chart of a sequence of operations of an anti-tampering mode of operation, in accordance with certain embodiments of the presently disclosed subject matter;

FIG. 4 illustrates a generalized flow-chart of a modified sequence of operations in the system of FIG. 1, in accordance with certain embodiments of the presently disclosed subject matter;

FIG. 5 illustrates a functional block diagram of a TPM (Trusted Platform Module) for use in a system, in accordance with certain embodiments of the presently disclosed subject matter;

FIG. 6 illustrates a generalized flow-chart of a sequence of operations in the system of FIG. 5, in accordance with certain embodiments of the presently disclosed subject matter; and

FIG. 7 illustrates a generalized flow-chart of a sequence of operations in the system of FIG. 5, in accordance with certain other embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that, throughout the specification, discussions utilizing terms such as “receiving”, “connecting”, “sending”, “inspecting”, “filtering”, “signing”, “determining”, “providing”, “analyzing”, “performing”, “verifying”, “aggregating”, “generating”, “erasing”, “extracting”, “disconnecting”, “deciphering”, “decrypting”, “applying” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the inspection computer and parts thereof, as well as the processing and memory unit and processor comprised therein as disclosed in the present application.

The terms “non-transitory memory” and “non-transitory storage medium” used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance”, and variants thereof, describe non-limiting embodiments of the presently disclosed subject matter. Reference in the specification to “one case”, “some cases”, “other cases”, or variants thereof, means that a particular feature, structure or characteristic described in connection with the embodiment(s) is included in at least one embodiment of the presently disclosed subject matter. Thus, the appearance of the phrase “one case”, “some cases”, “other cases”, or variants thereof, does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

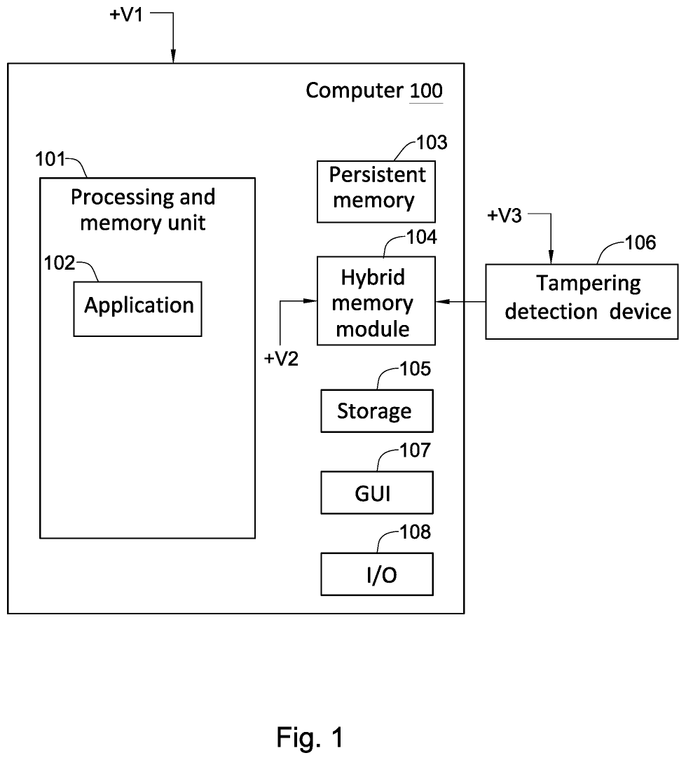

Bearing this in mind, attention is drawn to FIG. 1 illustrating a functional block diagram of a key management system, in accordance with certain embodiments of the presently disclosed subject matter.

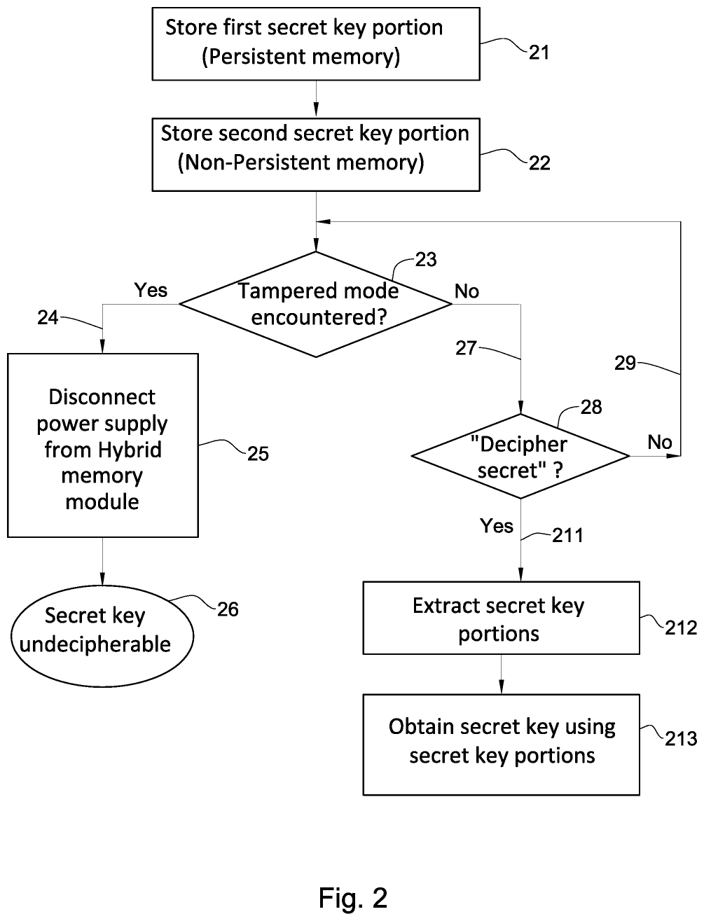

As illustrated, computer system 100 can comprise a processing and memory unit (PMU, also termed as processing unit) 101 operatively connected to a hardware-based I/O interface 108 and a memory unit 105, such as RAM. PMU 101 is configured to provide all processing necessary for operating system 100 as further detailed below with reference to FIGS. 2 to 7 below. PMU 101 comprises a processor (not shown separately) and a memory (not shown separately). The processor of PMU 101 can be configured to execute several functional modules in accordance with computer-readable instructions implemented on a non-transitory computer-readable memory comprised in the PMU. Such functional modules are referred to hereinafter as comprised in the PMU. It is to be noted that the term processor, referred to herein, should be expansively construed to cover any processing unit with data processing capabilities, and the present disclosure is not limited to the type or platform thereof, or the number of processing cores comprised therein.

Functional modules comprised in the PMU 101 can comprise one or more applications 102, operatively coupled to a persistent memory module 103. The persistent memory module, while illustrated as a distinct unit, may be composed of various components. In accordance with various embodiments, the persistent memory module (component), may be included in a Trusted Platform Module (TPM) (or component, whichever the case may be), or a Hardware Security Module (HSM) (or component, whichever the case may be). Note that whenever reference is made to a TPM, it may likewise apply to a HSM, mutatis mutandis.

Note that, in certain embodiments, certain functionalities of application 102 may reside in the persistent memory module 103, all as will be explained in greater detail below.

The application 102 is operatively coupled to a “hybrid” memory module 104. The “hybrid” memory is in fact a non-persistent memory, which, when deprived of power, all its content is instantaneously lost. However, and as will be explained in greater detail below, it is autonomously powered ((+V2). Accordingly, when the regular power (+V1) of computer 100 is off, memory 104 is nevertheless powered by its autonomous power (+V2) (subject to certain conditions), thereby conferring it with “persistent” characteristics. The “hybrid” memory module, while illustrated as a distinct unit, may be composed of various components. In accordance with various embodiments, the non-persistent memory module (component) may be included in a Real Time Clock (RTC) module (or component, whichever the case may be).

As will be explained in greater detail below, any of the persistent and “hybrid” memory modules (components) (or the TPM/RTC, whichever the case may be), may form part of the computer 100, or, in accordance with certain embodiments (not shown in FIG. 1), may be a separate hardware device(s) operatively coupled to said PMU, for instance a portable device such as a dongle or so-called Disk-On-Key connectable to the PMU through a communication interface (not shown in FIG. 1).

FIG. 1 also shows a separate tampering detection device 106, operatively coupled to computer 100, whose operation will be described in greater detail below. By this embodiment, the tampering detection device is autonomously powered (+V3) and may impact the “hybrid” memory module (all as will be explained in greater detail below). In certain other non-limiting embodiments, the tampering detection device may form part of the application 102, or be user operated, all as will be explained in greater detail below.

According to certain embodiments, system 100 can comprise a memory module 105. The memory unit 105 can be configured to store any data necessary for operating system 100, e.g., data related to input and output of system 100, as well as intermediate processing results generated by system 100. The memory unit 105 may be integral with or separated from the specified persistent and non-persistent memory module (components).

In some embodiments, system 100 can optionally comprise a computer-based User Interface (UI) 107 which is configured to enable user-specified inputs (such as a secret key portion) that is fed to the RTC (Real Time Clock) by the user and/or outputs related to system 100. For instance, the user may view the received data, and/or some of the inspection results on the GUI. Optionally, the user may be provided, through the GUI, with options of defining certain operation parameters of system 100. Note that the secret key portion may be fed through other means, say a communication interface such as Disk-On-Key, etc.

Those versed in the art will readily appreciate that the teachings of the presently disclosed subject matter are not bound by the system illustrated in FIG. 1; equivalent and/or modified functionality can be consolidated or divided in another manner and can be implemented in any appropriate combination of software with firmware and hardware.

It is noted that although the memory module 105 and UI 107 are illustrated as being part of the system 100 in FIG. 1, in some other embodiments, at least some of the units can be implemented as being external to system 100 and can be configured to operate in data communication with system 100 via I/O interface 108.

It should also be noted that in some cases the computer can be implemented as a stand-alone computer(s) (e.g., laptop, desktop, IPAD, and so forth).

Reference is now made to FIG. 2, illustrating a generalized flow-chart of a sequence of operations in a system of FIG. 1, in accordance with certain embodiments of the presently disclosed subject matter.

At the onset, a first secret key portion is stored in the persistent memory 103. Then a second key portion is stored in the “hybrid” memory portion 104. Assuming that no tampering is encountered (27), and a secret unlock command is invoked 28, 211 (say by application 102), then the application extracts the secret key portions 212 and generates the secret 213. Note that unlocking the key (referred to occasionally also as generating, constructing, obtaining recovering, etc.) may be achieved e.g. by using one secret key portion to unlock the other, and the so unlocked key constitutes the secret key, or, for example, by applying a function on the so extracted keys, say, by non-limiting example, concatenation, transformation of one based on the other, and so forth. The invention is not bound by the specified examples, and other paradigms for unlocking the secret key may be used, e.g., the known “shared secret” paradigm. Note also that while the description has focused, for clarity, on first and second portions, in accordance with certain embodiments, three or more portions may be used.

The so generated secret key may be applied to the protecting sensitive data, all depending upon the particular application, such as setting up secure communications such as a VPN, encryption/decryption, signing etc.

Note that whereas in FIG. 2 the application resided in PMU 101, in accordance with certain other embodiments, and as will be discussed in greater detail below, the application may reside, e.g. in the persistent memory, say the TPM.

Those versed in the art will readily appreciate that the specified scenario is susceptible to attack by an adversary party, in case the latter is able to extract the specified respective secret key portions from the specified persistent memory module 103 and the “hybrid” memory module 104, generate the secret key, and utilize it for malicious purposes. To this end, the tampering detection device 106, may be utilized and as shown in FIG. 2. The latter is configured to detect a tampering attempt (including actual penetration), e.g., an attempt to access the “hybrid” memory. As specified, the latter is a non-persistent memory module, which, in absence of power, all its content (including the second secret portion stored therein) is lost, with the inevitable consequence that the secret key cannot be generated and used, as one of its essential ingredients-the second key portion-cannot be extracted and used.

Reverting, thus, to step 23, in cases where a tampering attempt is detected (hereinafter “tampering mode”), then the tampering device is configured to disconnect (e.g. by means of appropriate command) the independent power supply of the “hybrid” memory (+V2), which leads to losing, instantaneously, any of the content stored therein, including the second key portion, before the adversary party has had a chance to extract it. Note that a tampering attempt may include any cyberattack, physical interaction, such as shaking the computer system), detection of light at various wavelengths, changes in temperature, physical touching, opening up the case in order to get physical access to the system internals and/or others, all depending upon the particular application.

It is noted that the teachings of the presently disclosed subject matter are not bound by the flow chart illustrated in FIG. 2, and that the illustrated operations can occur out of the illustrated order. It is also noted that whilst the flow chart is described with reference to elements of system (100), this is by no means binding, and the operations can be performed by elements other than those described herein.

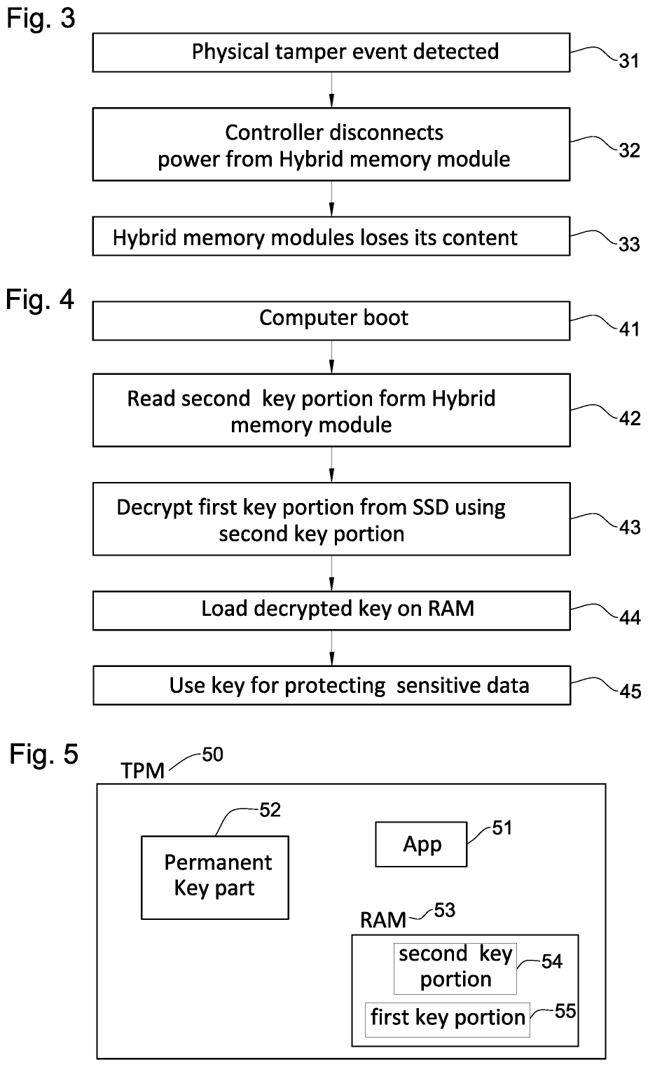

The specified sequence of operations is illustrated, schematically, in FIG. 3, where, in case of tampering attempt detection 31, an appropriate command is triggered by the tampering device, leading to disconnection of the power (+V2 in FIG. 1) from the “hybrid” memory module 32. As a result, the content stored therein (including the second secret portion) is erased (33) with the inevitable consequence that an adversary party will not be able to restore the secret. Note that while, in the drawings, the disconnect signal is depriving power from the module, the invention is not bound by this form of disconnection, e.g. in accordance with certain embodiments, sending a signal to the module's controller, which, in turn, disconnects power from the memory thereof, and consequently erases its content.

It is noted that the teachings of the presently disclosed subject matter are not bound by the flow chart illustrated in FIG. 3, and that the illustrated operations can occur out of the illustrated order. It is also noted that whilst the flow chart is described with reference to elements of system (100), this is by no means binding, and the operations can be performed by elements other than those described herein.

As previously indicated, the “hybrid” memory module is autonomously powered (say +V2), independently of computer system 100 and, as has been discussed above, the specified power is disconnected in response to detection of the tampering attempt, and thus the “hybrid” memory module may be regarded as non-persistent memory. The “hybrid” memory has, typically, a low power consumption and, accordingly, its independent power source (battery) has prolonged duration before it is depleted or recharged, therefore maintaining its content (including the second secret portion) throughout this long battery life duration. Hence, the second secret portion is safely stored and can be reliably extracted by a legitimate party, and in this respect the “hybrid” memory module may be regarded as persistent memory.

Alternatively, had the “hybrid” memory module been powered by the same power source (+V1) that powers computer system 100, then, when the battery of the latter is depleted (as often happens with, say, laptops) and before it is recharged, the content of memory module 104 would have been lost, requiring a cumbersome procedure of safely reloading the second secret key portion to the “hybrid” computer for future use. Note that keeping the second secret key portion “alive” while powering the “hybrid” memory module with the same power source V1, would necessarily entail that the user should never allow the battery that powers the computer to be fully depleted, which is obviously infeasible. In contrast, in accordance with certain embodiments of the presently disclosed subject matter, employing a durable and independent power source for powering the “hybrid” memory module 104 (rendering it “persistent” by virtue of the ongoing power supply) keeps the second secret key portion available for legitimate use, even if the battery that powers computer 100 is depleted. Note that losing the computer's power source (and until recharge) will not affect the first secret portion, as the latter is stored in a persistent memory module (103).

Note also that in accordance with certain embodiments, the “hybrid” memory module may be contained in an RTC (Real Time Clock) module, typically, having a non-persistent memory section powered by an independent battery, e.g., for maintaining the real-time clock data, even when the power of the computer system is switched off.

Attention is now drawn to FIG. 4, illustrating a generalized flow-chart of another sequence of operations in a system of FIG. 1, in accordance with certain embodiments of the presently disclosed subject matter. Thus, during computer boot phase 41, there is a need to restore the secret key for protecting sensitive data. A first secret key portion is stored on, say, SSD persistent memory, however in encrypted form, and in order to unlock it (43), a second key portion should be extracted from the hybrid memory portion (42). Once the key is unlocked, it may be loaded on the system RAM memory (44) and used for protecting the sensitive data 45. The whole process may be orchestrated by, say, application 102. As may be recalled, the manner of generating the secret key is not bound by using one key to unlock the other, and other alternatives may be used (e.g., a function, say, concatenation, may be applied to the first and second secret memory portions in order to generate the secret key).

It is noted that the teachings of the presently disclosed subject matter are not bound by the flow chart illustrated in FIG. 4, and that the illustrated operations can occur out of the illustrated order. It is also noted that whilst the flow chart is described with reference to elements of system (100), this is by no means binding, and the operations can be performed by elements other than those described herein.

Note that whereas, in accordance with certain embodiments, the tampering module is independently powered, in accordance with modified embodiments the anti-tampering module is associated with said PMU, and is operatively powered by said first power source, thereby being inoperative when said first power source is disconnected.

By another non-limiting example, the anti-tampering module is user operated, wherein, in response to a user command, a power disconnect signal is generated for disconnecting said second power source from the “hybrid” memory module, thereby erasing, instantaneously, said second secret key portion, giving rise to an undecipherable secret key, namely it cannot be unlocked. The invention is not bound by these examples of tampering modules.

Attention is now drawn to FIG. 5, illustrating a functional block diagram of a TPM for use in a system, in accordance with certain embodiments of the presently disclosed subject matter. In accordance with this embodiment, the application which orchestrates the whole sequence of constructing the secret key, is embedded in the TPM 50. Thus, by this embodiment, TPM 50 includes a processor (not shown) running an application 51, a permanent memory module 52 storing the first key portion, and a RAM memory module 53. Note that the “hybrid” memory module 104 (say RTC module) resides externally, and is not accommodated within the TPM module.

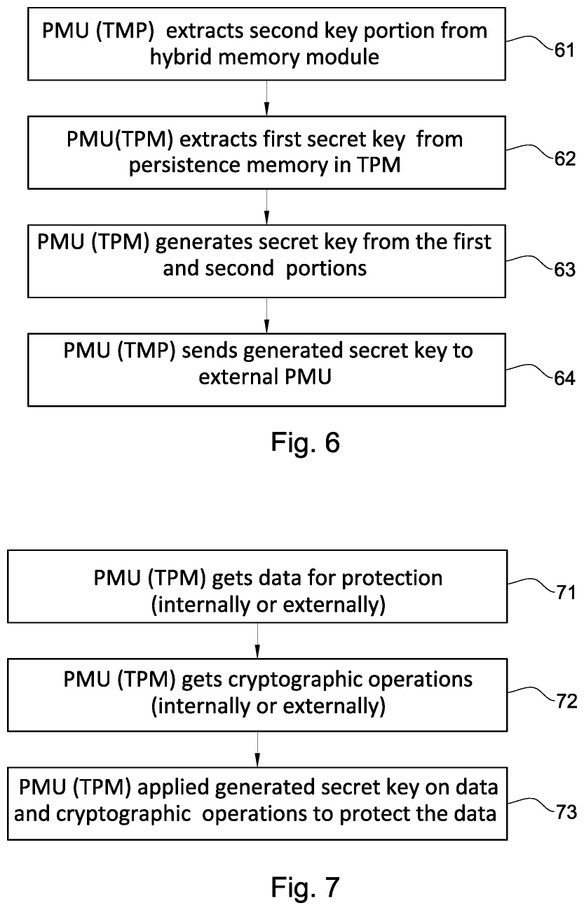

Attention is now drawn to FIG. 6, illustrating a generalized flow-chart of a sequence of operations in a system of FIG. 5, in accordance with certain embodiments of the presently disclosed subject matter. As shown, in response to an unlock key command, the application 61 extracts the second key portion from the “hybrid” memory module 104 and stores it (54) in RAM memory 53. The first key portion is extracted 62 from the persistent memory module 52 and stored (55) in RAM memory 53, and the secret key is generated 63 based on the first and second portions, all in a manner discussed in detail above with reference to various embodiments of the presently disclosed subject matter. The so generated key may be sent to the PMU 101 for encryption of the sensitive data.

It is noted that the teachings of the presently disclosed subject matter are not bound by the flow chart illustrated in FIG. 6, and that the illustrated operations can occur out of the illustrated order. It is also noted that whilst the flow chart is described with reference to elements of system (50), this is by no means binding, and the operations can be performed by elements other than those described herein.

Attention is now drawn to FIG. 7 illustrating a generalized flow-chart of a sequence of operations in a system of FIG. 5, in accordance with certain other embodiments of the presently disclosed subject matter. Thus, in accordance with a first non-limiting modified embodiment, the sensitive data to be protected also resides in, or is transmitted to, the TPM module 50.

It is noted that the teachings of the presently disclosed subject matter are not bound by the flow chart illustrated in FIG. 7, and that the illustrated operations can occur out of the illustrated order. It is also noted that whilst the flow chart is described with reference to elements of the system (50), this is by no means binding, and the operations can be performed by elements other than those described herein.

The application 51 then utilizes the so generated key (as described with reference to FIG. 6) for encrypting the sensitive data, and transmits the already protected (encrypted) sensitive data to, say, PMU 101, for further use. Still further, in accordance with yet another modified embodiment, the sensitive data to be protected does not only use the unlocked key, but also applies cryptographic functions that utilize the key for protecting the data (and/or utilizing cryptographic functions to unlock the key). The latter “concept” of utilizing cryptographic functions in the manner specified may be implemented in various embodiments of the presently disclosed subject matter. Reverting to FIG. 7, in accordance with certain embodiments, a designated cryptographic operator (or operators) is/are also provided to the TPM and the application 51 may utilize it (them) for generating the key (obviously based on the specified first and second secret key portions) and/or to protect the sensitive data utilizing, obviously, the so generated secret key.

The description below elaborates various (non-limiting) known per se attack scenarios which may end up with unauthorized retrieval or generation of the secret key.

Thus, consider a laptop containing a component which is physically accessed by a malicious actor who wishes to retrieve the secrets on it, typically encryption keys used for secure communications. This component (say an encryption device for a keyboard) needs to work autonomously, otherwise a simple solution to any attack would be for the user to input the secrets when needed, which is practically infeasible.

In accordance with a first security regime, the secrets are stored in a persistent memory, and, if the adversary gains physical access to the component, it allows him to read the keys from the component, thereby compromising its security.

In accordance with another security regime, the secrets are stored inside the TPM, and any application that needs them, would retrieve them from the TPM and use them. In the event of an attack being detected, if the component is up and running, it could send a command to the TPM to erase the secrets, however this would require a more complex set of commands from a more complex platform (say OS), and the more complex the platform is, the more power one would need in order to make it available all of the time.

Considering this known per se complexity of erasure of data from the TPM, its content is typically retained intact (including the secret stored therein), and, accordingly, the TPM is vulnerable in case an adversary party is willing to invest the efforts for accessing and retrieving the secret data stored in the TPM.

By still another variant of a security regime, even if a tampering attempt is detected and an effort is made to delete the secret data from the TPM, such erasure requires certain time duration, which an adversary may exploit by accessing and retrieving data before it is erased from the TPM. In case that the computer that accommodates the TPM is not up and running, it will obviously not detect an attempt to access the TPM, and will not send a command to erase the secret data, and consequently the adversary party can access the TPM in no rush, get the secrets, and thereby breach the security.

By yet another security regime, the application needs to use some kind of passphrase in order to unlock the secrets inside the TPM. However, this passphrase is either stored someplace persistent (and accessible) in the component, or is supplied by an external entity (e.g., the user) and therefore is vulnerable to be accessed and unduly used by the adversary.

In all of the above cases, the secrets are either exposed (themselves, or their usage) in a persistent storage or the TPM, or, in order to protect them, an external, manual input of a passphrase is required in order to unlock them.

In contrast, the specified attack scenarios are not feasible when the techniques according to the teaching of various embodiments of the invention are used, since an essential secret key portion is always available on the one hand (when needed for legitimate generation of the secret key), but easily erased on the other hand, when a tampering attempt is encountered. Note also that the proposed technique provides robust protection, even when the computer (say laptop) power is switched off, considering that the anti-tampering device which is autonomously powered (independently of the computer system), will sense a tampering attempt, and, as a result, will disconnect the power from the “hybrid” memory (say the RTC) with the immediate consequence that all the data stored therein is immediately erased, prohibiting the adversary to generate the secret, all as discussed in detail above. Note that in accordance with certain embodiments, the anti-tampering device has, typically, a low power consumption and, accordingly, its independent power source (battery) has prolonged duration before it is depleted or recharged, therefore maintaining it active for detecting tampering attempts (throughout this long battery life duration), even when the computer (say laptop) is shut off after its power source (battery) is depleted.

Thus, in accordance with various embodiments, a combination of the following characteristics is attained:
(i) The secret key can be generated from secret key components that are stored on persistent memory (e.g., TPM) and “hybrid” memory (e.g., RTC).
(ii) The non-persistent memory can be erased with a simple signal (for example, disconnecting its power) in response to detection of a tampering attempt, and the erasure will occur within a very short time of the order of a fraction of a second.

The net effect is that once an essential secret key portion (that resides on the non-persistent memory) is erased, an adversary cannot restore the secret key, and the security regime cannot be compromised. This holds true even if the adversary managed to access the persistent memory and access the secret key portion stored therein. Note that even if the persistent memory is protected by an anti-tampering device which will trigger a memory erase signal in response to an attempt to tamper with the persistent memory, an adversary can still take advantage of the relatively long time interval that should elapse until the persistent memory is properly erased, and access to the secret key portion that is stored therein is erased. This, however, will have no bearing on the security regime according to various embodiments of the invention, because, as explained above, the adversary will most likely fail to extract the other secret key portion that was instantaneously erased from the non-persistent memory module, and, in the absence of the latter, he will not be able to restore the secret key.

Note that in accordance with an aspect of the invention, the computerized system does not utilize the persistent memory module for storing a secret key portion, but rather the entire secret key is stored in the hybrid memory module (say the RTC), and the various embodiments described above apply, mutatis mutandis.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized system operatively powered by a first power source, the system comprising:
a processor and memory unit (PMU);
a persistent memory module associated with said PMU and configured to store a first secret key portion;
a “hybrid” memory module associated with said PMU and being configured to store a second secret key portion and further being operatively powered by a second power source independent of the first power source, thereby maintaining said second key portion, even when the first power source is disconnected from the computerized system;
an anti-tampering module configured to detect tampering with the computerized system, and, in response thereto, generate, in an anti-tampering mode of operation, a power disconnect signal, for disconnecting said second power source from the “hybrid” memory module, thereby instantaneously erasing said second secret key portion, giving rise to an undecipherable secret key.

2. The computerized system of claim 1, wherein, in case said anti-tampering mode is not encountered, in response to an “unlock secret” command, the PMU is configured to extract said first secret key portion from said persistent memory module and said second key portion from said “hybrid” memory portion, and unlock a secret key based on at least said first secret portion and second secret portion, wherein said unlocked secret key can be applied to said sensitive data.

3. The computerized system of any one of claim 1 or 2, wherein said persistent memory portion is included in a Trusted Platform Module (TPM).

4. The computerized system of claim 3, wherein said PMU is embedded in said TPM and is configured to extract said first secret key portion from the TPM and said second key portion from said “hybrid” memory portion, and unlock a secret key based on at least said first secret portion and second secret portion.

5. The computerized system according to any one of the preceding claims, wherein said “hybrid” memory module is a Real Time Clock (RTC) module configured to store said second secret key portion.

6. The computerized system according to any one of the preceding claims, wherein said anti-tampering module is separate from said PMU, and is operatively powered by a third power source independent of the first and second power sources, thereby maintaining said anti tampering module as operative, even when said first power source is disconnected.

7. The computerized system according to any one of claims 1 to 5, wherein said anti-tampering module is associated with said PMU, and is operatively powered by said first power source, thereby being inoperative when said first power source is disconnected.

8. The computerized system according to any one of the preceding claims, wherein said anti-tampering module is user operated, wherein, in response to a user command, a power disconnect signal is generated for disconnecting said second power source from the “hybrid” memory module, thereby instantaneously erasing said second secret key portion, giving rise to an undecipherable secret key.

9. The computerized system according to any one of the preceding claims, wherein said PMU is configured to obtain said secret key by unlocking the first secret key portion utilizing at least said second secret key portion, or vice versa.

10. The computerized system according to any one of claims 1 to 8, wherein said PMU is configured to obtain said secret key by applying a function on said first secret key portion and said second secret key portion.

11. The computerized system according to any one of claims 4 to 10, wherein said PMU is configured to receive sensitive data for protection and associated at least one cryptographic operation and utilize said unlocked secret key and cryptographic operations for encrypting said sensitive data.

12. The computerized system according to any one of claims 4 to 10, further comprising a second PMU separate from said PMU, and being configured to utilize said secret key for encrypting sensitive data.

13. The computerized system according to any one of the preceding claims, wherein said second portion is extracted during a boot stage of the computerized system.

14. The computerized system according to any one of the preceding claims, wherein said persistent memory module is configured to erase data stored therein after the elapse of a first time duration following disconnection of said first power source, and wherein the “hybrid” memory module is configured to erase data stored therein after the elapse of a second time duration following disconnection of said second power source, and said second time duration is significantly shorter than said first time duration.

15. A computerized system operatively powered by a first power source, the system comprising:
a processor and memory unit (PMU);
a “hybrid” memory module associated with said PMU and being configured to store a secret key, and further being operatively powered by a second power source independent of the first power source, thereby maintaining said secret key, even when the first power source is disconnected from the computerized system;
an anti-tampering module configured to detect tampering with the computerized system, and, in response thereto, generate, in an anti-tampering mode of operation, a power disconnect signal, for disconnecting said second power source from the “hybrid” memory module, thereby instantaneously erasing said secret key, giving rise to an undecipherable secret key.

16. The computerized system of claim 15, wherein, in case said anti-tampering mode is not encountered, in response to an “unlock secret” command, the PMU is configured to extract said secret key from said “hybrid” memory portion, and unlock the secret key, wherein said unlocked secret key can be applied to said sensitive data.

17. A computerized method for unlocking a secret key, comprising, by a computer system operatively powered by a first power source:
a) providing a processor and memory unit (PMU);
b) storing a first secret key portion in a persistent memory module associated with said PMU;
c) storing a second secret key portion in a “hybrid” memory module associated with said PMU, the “hybrid” memory module being operatively powered by a second power source independent of the first power source, thereby maintaining said second key portion, even when the first power source is disconnected from the computerized system; and
d) in response to detecting tampering with the computerized system, generating, in an anti-tampering mode of operation, a power disconnect signal, for disconnecting said second power source from the “hybrid” memory module, thereby instantaneously erasing said second secret key portion, giving rise to an undecipherable secret key.

18. The computerized method of claim 17, wherein in case said anti-tampering mode is not encountered, the method further comprises:
e) executing an “unlock secret” command including:
1. extracting said first secret key portion from said persistent memory module and said second key portion from said “hybrid” memory portion; and
2. unlocking a secret key based on at least said first secret portion and second secret portion, wherein said unlocked secret key can be applied to said sensitive data.

19. The computerized method of any one of claim 17 or 18, wherein said persistent memory portion is included in a Trusted Platform Module (TPM).

20. The computerized method of claim 19, wherein said PMU is embedded in said TPM, and comprises:
(1) extracting said first secret key portion from the TPM and said second key portion from said “hybrid” memory portion, and
(2) unlocking a secret key based on at least said first secret portion and second secret portion.

21. The computerized method according to any one of claims 17 to 20, wherein said “hybrid” memory module is a Real Time Clock (RTC) module configured to store said second secret key portion.

22. The computerized method according to any one of claims 17 to 21, further comprising unlocking the first secret key portion utilizing at least said second secret key portion, or vice versa.

23. The computerized method according to any one of claims 17 to 22, further comprising obtaining said secret key by applying a function on said first secret key portion and said second secret key portion.

24. The computerized method according to any one of claims 17 to 23, further comprising extracting said second portion during a boot stage of the computerized system.

25. The computerized method according to any one of claims 17 to 24, further comprising erasing data stored in said persistent memory after the elapse of a first time duration following disconnection of said first power source, and erasing data stored in the “hybrid” memory module after the elapse of a second time duration following disconnection of said second power source, and said second time duration is significantly shorter than said first time duration.

26. A computerized method for unlocking a secret key comprising by a computer system operatively powered by a first power source:
a) providing a processor and memory unit (PMU);
b) storing a secret key portion in a “hybrid” memory module associated with said PMU, the “hybrid” memory module being operatively powered by a second power source independent of the first power source, thereby maintaining said secret key, even when the first power source is disconnected from the computerized system; and
c) in response to detecting tampering with the computerized system, generating, in an anti-tampering mode of operation, a power disconnect signal, for disconnecting said second power source from the “hybrid” memory module, thereby instantaneously erasing said secret key portion, giving rise to an undecipherable secret key.

27. The computerized method of claim 26, wherein in case said anti-tampering mode is not encountered, the method further comprises:
d) executing an “unlock secret” command including:
1. extracting said secret key portion from said “hybrid” memory portion; and
2. unlocking a secret key, wherein said unlocked secret key can be applied to said sensitive data.
